(19) United States
(12) Patent Application Publication
(10) Pub. No.: US 2008/0254321 A1
(43) Pub. Date: Oct. 16, 2008

(54) Coatings for Particle Reduction

(76) Inventors: Jason M. Kehren, Woodbury, MN (US); Gregory D. Clark, St. Paul, MN (US); Michael A. Lockott, St. Paul, MN (US); Richard M. Flynn, Mahtomedi, MN (US)

Correspondence Address: 3M INNOVATIVE PROPERTIES COMPANY, PO BOX 33427, ST. PAUL, MN, 55133-3427, US

(21) Appl. No.: 11/813,012

(22) PCT Filed: Dec. 30, 2005
(86) PCT No.: PCT/US2005/047446

§ 371 Date: Oct. 22, 2007

Related U.S. Application Data
(60) Provisional application No. 60/640,658, filed on Dec. 30, 2004.

(51) Int. Cl. G11B 5/33

(52) U.S. Cl. 428/810

(57) ABSTRACT

Coatings for particle suppression are provided. Such coatings comprise fluorochemical moieties and reactive pendant groups.

### FIELD

The present invention relates to high purity apparatuses, e.g., magnetic hard disk drives, and more specifically, to coatings for particle reduction in such apparatuses.

### BACKGROUND

In magnetic disk drives and other high purity applications, particle contamination can cause a host of failure mechanisms. In these applications, it is highly desirable to minimize particles present in manufacturing and during application. Magnetic disk drives typically comprise a number of precisely dimensioned operating parts, e.g., spacers, disk clamps, e-blocks, cover plates, base plates, actuators, voice coils, voice coil plates, etc. These components can all be potential sources of particles. During drive operation, the head typically flies over the media at a spacing of about 100 Å. This spacing is decreasing with increasing areal density, making the reduction and prevention of particle generation ever more critical. Particles at the head disk interface can cause thermal asperities, high fly writes, and head crashes; any of these are detrimental to performance of a disk drive.

U.S. Publication No. 2003/0223154 A1 (Yao) discloses prevention of particle generation by encapsulation with a coating “made of a soft and tenacious material, such as gold, platinum, epoxy resin, etc.”. U.S. Publication No. 2002/0093766 A1 (Wachtler) discloses the use of adhesive-backed heat shrinkable conformal films to protect against particle generation. U.S. Pat. No. 6,671,132 (Crane et al.) discloses the use of metal or polymeric coatings. U.S. Publication No. 2004/0070885 A1 (Kikkawa et al.) discloses the use of resin coatings. U.S. Pat. No. 6,903,861 (Huha et al.) discloses the use of certain polymer coatings as an encapsulant for microactuator components.

The need exists for improved coatings for particle suppression in devices such as magnetic disk drives.

### SUMMARY

This invention provides an improved coating for particle suppression, e.g., from substrates such as aluminum, copper, etc. Coatings of the invention can be applied with simple techniques (e.g., dip coating and thermal cure), exhibit thermal stability to about 175° C., can be formed in substantially uniform thin (e.g., from about 0.1 to about 5.0 microns) layers over complex substrate topographies. Coatings of the invention are clean (i.e., low outgassing, low emission of extractable ions), are resistant to typical cleaning processes (e.g., aqueous and solvent-based cleaning solutions with or without ultrasonic treatment), are environmentally benign (i.e., delivered with solvents such as segregated hydrofluoroethers or water), have a good safety profile, and provide relatively superior cost-to-benefit performance as compared to the current industry method of nickel coating. The coatings of the invention may also provide corrosion protection.

Coatings of the invention comprise a thin polymer coating with reactive pendant groups having crosslinking functionality and superior ability to anchor to the substrate surface to suppress particle shedding from substrate surfaces. These particles may be from the substrate material or materials left over from processing and/or incomplete cleaning. This coating, in essence, forms a net over the surface of the substrate holding in particles, which otherwise could shed from the substrate. As used herein, “pendant” is intended to refer to end groups and side groups.

In brief summary, coatings of the invention comprise the reaction product of compound comprising fluorochemical portion and reactive pendant groups wherein the coating is at least partially cured in situ on the substrate. When at least partially cured in place, such coatings have been found to provide surprisingly good performance as particle reduction coatings on substrates.

Coatings of the invention may be of use in a variety of high purity applications such in hard disk drive assemblies including such components as spacers, disk clamps, e-blocks, cover plates, base plates, microactuators, sliders, voice coils, voice coil plates etc. These components are all potential sources of particles in finished disk drive systems. Coatings of the invention may also be used to reduce particle shedding for MEMS (Micro Electrical-Mechanical Systems), high purity processing (coating process equipment to reduce potential contamination), and semiconductor processing applications, e.g., surface mount components on a printed circuit card assembly.

### DETAILED DESCRIPTION OF ILLUSTRATIVE EMBODIMENTS

In brief summary, coatings of the invention comprise fluorochemical moieties, i.e., as the backbone or as side groups. and reactive pendant groups.

In some embodiments, coatings of the invention will comprise the fluorochemical moieties that are selected from the group consisting of perfluorinated polyethers and fluorinated acrylate copolymers.

In some embodiments, the reactive pendant group moieties are selected from the group consisting of reactive silane groups, reactive epoxy groups, and reactive melamine groups.

For example, we have discovered that coatings made from perfluoropolyethers with silane end groups are effective at reducing particles shed from, e.g., aluminum and copper. The general structure of the material is:

(RO)₃Si—(CH₂)_{b}—NHC(O)CXF—(O(CFR¹)ₐ)ₚ(O(CFR¹CF₂)ₐ)_{q}—OCFXC(O)NH—(CH₂)_{b}—Si(OR)₃

wherein R may be a methyl or ethyl group, R¹ is a F or CF₃, X is F or CF₃, a is an integer from 1 to 4, b is an integer from 1 to 10, p is an integer from 1 to 145, and q is an integer from 0 to 145, and the number average molecular weight of the polymer may range from about 500 to about 10,000. The groups of subscripts p and q may be randomly distributed in the chain.

In some other embodiments, the general structure of the material is: (RO)₃Si—(CH₂)_{b}—NHC(O)CXF(OC₃F₆)_{y}O(CF₂)_{z}O(C₃F₆O)ₓCFXC(O)NH—(CH₂)_{b}—Si(OR)₃ wherein R may be a methyl or ethyl group, X is F or CF₃, x and y may be the same or different and are each an integer from 0 to 10, with the proviso that at least one is not 0, and z is an integer from 2 to 10.

If the molecular weight of the finished coating is too low, the resultant coating may tend to be unduly brittle. It is generally preferred that the coating exhibit some degree of flexibility such that the coating maintains anchorage and avoids brittle fracture during operation of the assembly as the coated device flexes, expands, and or contracts.

In some other embodiments of the invention the general structure of the coating material is:

(RO)₃Si—(CH₂)₃—NHC(O)CX¹F—(O(CFR¹)ₐ)ₚ(O(CFR²CF₂)ₐ)_{q}—OCFX²C(O)NH—(CH₂)₃—Si(OR)₃.

wherein R may be a methyl or ethyl group, R¹ and R² may be the same or different are a F or CF₃, X¹ and X² may be the same or different is F or CF₃, a is an integer from 1 to 4, b is an integer from 1 to 10, p is an integer from 1 to 145, and q is an integer from 0 to 145, and the number average molecular weight of the polymer may range from about 500 to about 10,000. The groups of subscripts p and q may be randomly distributed in the chain.

An illustrative example of a suitable material is the following:

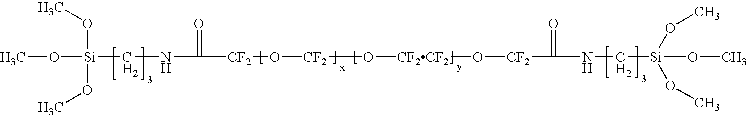

which is available from 3M Company as 3M™ Easy Clean Coating ECC-1000. The groups of subscripts x and y may be randomly distributed in the chain. These materials are disclosed in U.S. Pat. No. 6,613,860 (Dams et al.) which is incorporated herein by reference in its entirety.

Preferably the substrate and coating are selected such that the coating is anchored to the substrate surface via covalent bonding. The reactive pendant groups, i.e., silane groups in this example, on the molecule contribute to this desired bonding performance. In addition, while we do not wish to be bound by this theory, it is believed that the coating may provide superior corrosion protection as the silane groups react with bonds sites on the substrate that would otherwise be susceptible to corrosion reactions.

The coating thickness may be on the order of or substantially smaller than the size of the particles being held on the substrate, e.g., coating thickness in the range of 0.01 to 1.0 micron as compared to an average particle size in the range of about 0.1 to more than 5 microns.

In the presence of water, the OR group will react to form a silanol group on the polymer. The silanol group will react with other silanol groups, thus crosslinking the polymer, and in the case of oxide surfaces (e.g., aluminum, copper, silicon, and ceramic materials), covalently bonding the polymer to the surface.

The curing rate of the coating material may be enhanced as desired by addition of effective amounts of suitable catalyst depending upon the selection of reactive groups, parameters of the substrate, desired processing conditions, etc. For example, for coatings made using a perfluoropolyether silanes may be catalyzed using such agents as KRYTOX™ 157 FSL from DuPont.

In other embodiments, wherein the polymers have reactive pendant hydroxyl or carboxylic acid groups and are cross linked with melamine, an acid catalyst (e.g., NACURE™ 2558 a blocked acid catalyst) may be added.

In some embodiments, it is preferred to use a two stage curing process. In the first stage, the coating composition is partially cured to a first state at which it is no longer tacky but in which there are still reactive pendant groups, e.g., free silane groups, in the composition. In this state the coated article is conveniently worked with. Following positioning of a subsequent article such as a “form-in-place gasket”, e.g., a curable epoxy-based composition, the coating and article are cured in contact and achieve good adhesion.

It has also been observed that superior results are typically achieved if the coating is cured by heating at a relatively lower temperature for longer time than if cured by heating at a higher temperature for shorter time, e.g., at 120° C. rather than 150° C.

Another advantage of coatings of the invention is that they exhibit a low tendency to absorb or “pick up” organic materials during brief contacts, e.g., contaminants and other agents during cleaning, thus coatings of the invention tend to outgas less than many alternative materials.

Subsequent adhesion to articles with coatings of the invention can be improved by wiping with a fluorochemical solvent shortly before bonding.

### EXAMPLES

The invention will be explained with the following non-limiting examples. The substrates used for testing are coupons made from the material indicated. Coupons were shear cut from stock material and holes drilled near a corner to permit the coupon to be suspended during testing.

### Cleaning Method 1

Substrates were cleaned prior to coating by vapor degreasing with 3M™ NOVEC™ HFE-72DA (available from 3M Co. of St. Paul, Minn.). The cleaning was done in a two sump vapor degreaser, model number B452R, obtained from Branson Ultrasonics Corporation of Danbury, Conn., using the following operating parameters:

30 seconds initial vapor rinse,

3 minutes in the rinse sump (no ultrasonics), and

30 seconds final vapor rinse,

### Cleaning Method 2

Substrates were cleaned prior to coating by immersing in acetone for 10 minutes. Substrates were then laid flat and sprayed with 2-propanol (approximately 100 ml were used for 20 substrates). The residual 2-propanol was then removed by wiping and substrates were allowed to dry overnight.

### Cleaning Method 3

Substrates were cleaned prior to coating by wipe cleaning using CMOS grade 2-propanol (available from JT Baker of Phillipsburg, N.J.) and VWR Spec-Wipe 4 wipers (available from VWR International of West Chester, Pa.). Coupons were then immersed in 18.2 MΩ water filtered with a 0.2 micron (absolute) filter and sonicated for 90 seconds with 68 kHZ ultrasonics using 40 watts per gallon power. Coupons were dried by wiping with VWR Spec-Wipe 4 wipers.

### Coating Method

All coatings were applied by dip coating. Pull rates used for these studies ranged from 1.7 to 3.6 mm/s (4 to 8.5 in/min). Substrates were suspended by holes in the substrate using paper clips and were completely immersed during the dip coating process. Curing varies depending on the polymer; specifics for each polymer are discussed below.

### Crosshatch Adhesion

Crosshatch adhesion or cross-cut tape adhesion was measured using ASTM D3359-95a, test method B with two modifications. First, a four by four cross cut was used as opposed to the recommended eleven by eleven cut for coatings below 2 mils. Second, in addition to visual observation, a Sharpie marker was used to indicate the presence of the coating. Fluorochemical coatings repel the marker. If the coating was removed, the substrate was easily marked,

### Extraction

LPC extraction was performed using a method based on the IDEMA Microcontamination Standards M9-98. The substrate was completely immersed in 18.3 MΩ water and was exposed to ultrasonics (40 Watts/gallon, 40 or 68 kHz) for 30 seconds. The particle levels in the water were analyzed with a liquid particle counter.

LPC extraction was performed in a class 1000 clean room environment. 18.3 MΩ water filtered to 0.1 micron was used for all portions of this testing. The test apparatus consisted of a 1000-ml KIMAX™ beaker (obtained from VWR International) fixtured in an ultrasonic tank. The parts to be tested were immersed in the beaker using a 28 gauge, solderable polyurethane stator wire (obtained from MWS Wire Industries of Westlake Village, Calif.; part number 28 SSPN). Particle levels in the fluid were measured using a HIAC ROYCO™, Micro Count 100 (obtained from Hach Ultra Analytics of Grants Pass, Oreg.).

Prior to each test sample, a blank was run to assess the cleanliness of the beaker and water. The beaker was rinsed with water and then filled with 1000-ml of water.

Once a good blank was established, the test sample was immersed in the water. The test sample was hung so that it was completely submerged and did not touch the walls of the beaker. Ultrasonics were applied for 30 seconds. A 50 ml sample of the fluid was taken for LPC analysis. The particle counts per surface area of the test sample were calculated by:

$$\frac{( test sample particle count - blank particle count ) * 1000 mL}{50 mL * test sample surface area}$$

Three separate test samples were run for each coating condition. Averaged results are presented in the tables. In most cases, multiple extractions were run on each test sample, usually three.

### Coating Materials

Examples 1 and 2 were coated with ECC-1000, a perfluoropolyether with siloxane end groups, obtained from 3M Co. of St. Paul, Minn. The general structure of FC I is:

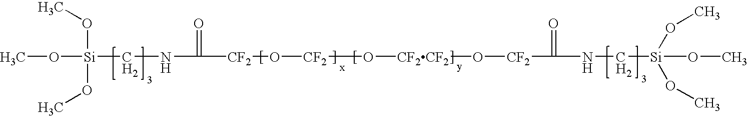

The polymer was delivered out of 3M™ NOVEC™ Hydrofluoroether HFE-7100. KRYTOX™ 157 FSL, a perfluoropolyalkylether carboxylic acid mixture obtained from DuPont of Wilmington, Del., was added as 2% of the total polymer solids (i.e., 0.2 g of KRYTOX™ 157 FSL and 9.8 g of ECC-1000 in 90 g of HFE-7100).

Examples 3 to 5 were coated with an aqueous solution comprising a reactive fluorochemical copolymer (synthesis described below), UD350W (polyurethane diol obtained from King Industries of Norwalk, Conn.), RESIMENE™ 747 (methylated melamine obtained from Solutia, Inc. of St. Louis, Mo.), NACURE™ 2558 (blocked acid catalyst obtained from King Industries of Norwalk, Conn.) and SILWETT™ L-77 (silicone polyether copolymer obtained from Helena Chemical Co. of Fresno, Calif.).

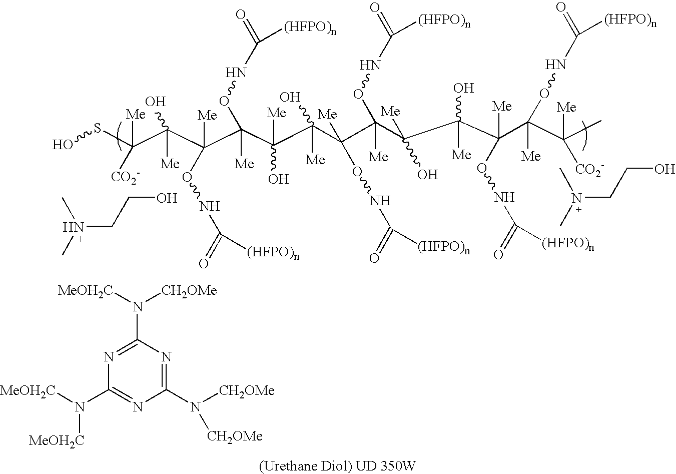

The reactive fluorochemical copolymer, FC II, was synthesized using the following components:

60 g HFPOMA (hexafluoropropylene oxide methacrylate)

27 g HEMA (hydroxyethylmethacrylate)

10 g MAA (methacrylic acid)

3 g ME (methyl acrylate)

300 g IPA (2-propanol)

1 g VAZO™ 67 (a free radical initiator available from DuPont)

10.3 g DMEA (dimethylaminoethanol)

233 g DI water.

HFPOMA, HEMA, MAA, ME, and IPA were charged into a flask followed by VAZO™ 67. The materials were stirred to form a solution. The solution was purged with nitrogen for 7 minutes. The solution was heated to 65° C. for 18 hours. Following this period, DMEA was added. The resulting solution was stirred for 3 minutes and the DI water added. The reaction mixture became foamy and formed a solution after approximately 2 minutes. The IPA was distilled from the solution under reduced pressure to give an aqueous solution.

| Component | Examples 3 and 4 | | Example 5 | |
|---|---|---|---|---|
| DI Water | 910.5 | g | 913.6 | g |
| UD350W | 44.1 | g solution | 75.4 | g solution |
| 88% solids | (38.8 | g solids) | (66.4 | g solids) |
| RESIMENE ™ 747 | 56.5 | g solution | 30.8 | g solution |
| 98% solids | (55.4 | g solids) | (30.1 | g solids) |
| NACURE ™ 2558 | 22.2 | g solution | 19.3 | g solution |
| 25% solids | (5.5 | g solids) | (4.8 | g solids) |
| Reactive FC Polymer | 14.6 | g solution | 10.2 | g solutions |
| 29.9% solids | (3.1 | g solids) | (3.1 | g solids) |
| SILWET ™ L-77 | 2.2 | g solution | 0.6 | g solution |
| 100% solids | | | (0.6 | g solids) |
| DS-10 (100% solids) | 0 | g solution | 0 | g solution |
| | (0 | g solids) | (0 | g solids) |

Compositions listed in Table 1 were prepared as follows. UD350W was charged, with stirring, to a beaker containing DI water. Following dissolution of the UD350W, the RESIMENE™ 747 was added. The NACURE™ 2558 was added to the resulting solution and, after 2 min, the reactive FC II was added followed by Silwet™ L-77.

There is no Example 6.

Example 7 was coated with a hexafluoropropylene oxide polymer with siloxane end groups.

For Example 7, a coating of the silane (C₂H₅O)₃SiC₃H₆NHCOCF(CF₃)[OCF(CF₃)CF₂O]ₙC₄F₈O[CF(CF₃)CF₂O]ₘCF(CF₃)CONHC₃H₆Si(OC₂H₅)₃ was prepared as follows.

The methyl ester precursor to the silane product was prepared by reaction of perfluorosuccinyl fluoride (FCOC₂F₄COF; 24 g, 51% purity; 0.064 mole) and hexafluoropropylene oxide (109 g, 0.65 mole) in tetraethylene glycol dimethyl ether solvent (341 g; added over about 40 hours) in the presence of cesium fluoride (15.5 g) at −20° C. After the reaction was completed the resulting diacid fluoride mixture was treated with a large excess of methanol at ambient temperature to convert the acid fluoride to the dimethyl ester of the nominal structure shown below (m+n is approximately 5 to 7), the lower product phase separated from the upper methanol/tetraglyme phase and the bottom phase washed with water to afford 111 g ester product:

MeO₂CCF(CF₃)[OCF(CF₃)CF₂O]ₙC₄F₈O[CF(CF₃)CF₂O]ₘCF(CF₃)CO₂Me (122 g).

The ester was combined with material made in a similar manner and distilled twice with the fractions of distillation range 38° C. to 198° C./0.7 mm Hg removed and the remaining distillation residue used for the silane synthesis. The average sum of m+n for the final product was 7.6 by glc.

This material (14.9 g) was treated with aminopropyltriethoxysilane (4.5 g, 0.02

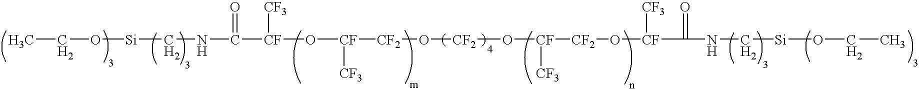

mole) without solvent. A small amount of silane was added after about 24 hours to convert the remaining ester functionality to the product silane. The IR band for the amidosilane appeared at 1709 cm⁻¹.

Example 8 was coated with aqueous fluorochemical urethane silanol, FC IV, dispersions. FC IV was prepared as follows:

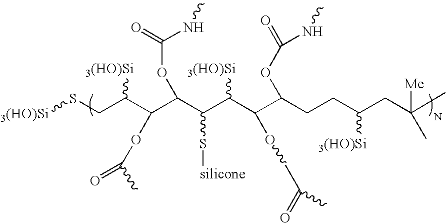

30 g ODA (octyldecyl acrylate), 30 g UMA, 20 g A-174 (silane acrylate obtained from OSi Specialties, Inc., Danbury Conn.), 10 g KF-2001 (mercaptosilicone), 10 g MPTS (mercaptopropyltrimethoxysilane), and premix of 9.5 g methyl isobutyl ketone (MIBK) and 0.5 g VAZO™ 67, (a clear solution when placed in a hot tap water bath) was combined in a glass jar with Teflon-lined cap. The mixture was sparged with nitrogen, sealed, and tumbled in a launderometer at 65° C. for 24 hours. The resulting MIBK solution was stirred at 60° C. while sonicating as a DI water/TWEEN 20 (5% of total solids) solution also at 60° C. was added. The resulting emulsion was sonicated for 3 minutes. The MIBK was removed by distillation at a reduce pressure to give a stable aqueous emulsion. SILWETT™ L-77 was added to improve the film forming properties.

Example 9 was coated with a fluorochemical acrylate copolymer of the following general formula:

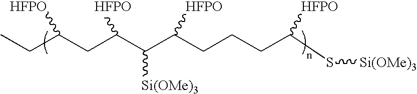

delivered out of HFE-7200 (available from 3M Company of St. Paul, Minn.). The copolymer was synthesized by charging 47.6 g of oligomeric hexafluoropropyleneoxideamidoethyl methacrylate (of the formula C₃F₇O(CF(CF₃)CF₂O)ₙCF(CF₃)CONHC₂H₄OCOC(CH₃)═CH₂ wherein n was 3 or greater), 0.95 g A174 (3-Trimethoxysilanepropyl methacrylate), 1.4 g MPTS (3-mercaptopropyl trimethoxysilane) and 220 g HFE 7200 to a 1 liter flask. The flask was equipped with a mechanical stirrer and placed under N₂ purge for 10 min with stirring. Following this period, 2 grams of solution (1 gram of solids) of LUPEROX™ 26M50 initiator (from Arkema, Inc., of Philadelphia, Pa.) was added and the reaction mixture was heated to 70° C. for 18 hours.

Example 10 was coated with a fluorochemical acrylate copolymer of the following general formula:

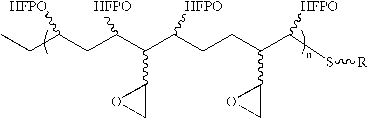

delivered out of HFE 7200. The copolymer was synthesized by adding 40 g oligomeric hexafluoropropyleneoxideamidoethyl methacrylate (of the formula C₃F₇O(CF(CF₃)CF₂O)ₙCF(CF₃)CONHC₂H₄OCOC(CH₃)═CH₂ wherein n was 3 or greater), 5 g 3-glycidoxypropyl methacrylate, 5 g methyl-3-mercaptopropionate, and 230 g HFE 7200 in a 1 liter flask. The flask was equipped with a mechanical stirrer and place under N₂ purge for 10 min with stirring. Following this period, 2 grams of solution (1 gram of solids) of LUPEROX™ 26M50 initiator was added and the reaction mixture was heated to 70° C. for 18 hours. A trace of insoluble precipitate was filtered out of the copolymer solution.

### Examples 1 and 2

TABLE 2
Example 1 and 2 Parameters for Coating

| | Example Number | |
|---|---|---|
| | 1 | 2 |
| Substrate Type | Aluminum 6061 | Copper |
| Substrate Size | 50 mm × 25 mm × 1.6 mm | 60 mm × 25 mm × 0.5 mm |
| Percent Solids | 10% by weight | 10% by weight |
| Catalyst | Yes | No |
| Pull Rate | 1.7 mm/sec | 3.5 mm/sec |
| Cure | 150° C. | 85° C. |
| Temperature | | |
| Cure Time | 30 minutes | 30 minutes |

For example 1, all the coupons were cleaned using Cleaning Method 1. Four coupons were coated and three coupons were left uncoated as controls. One coated coupon was tested using the cross-cut tape test. No removal of the coating was observed. The remaining three coated and uncoated coupons were tested by LPC extraction. The results are shown in Table 3. Each data point in the table is the average of three coupons at each condition.

TABLE 3
LPC Extraction Results at 68 kHz for Example 1

| | | Particle Count per Surface Area for Each | | | | |
|---|---|---|---|---|---|---|
| | Extract | Particle Bin (#/cm²) | | | | |
| | # | 0.30-0.39μ | 0.50-0.79μ | 1.0-1.9μ | >5μ | >0.3μ |
| Uncoated | 1 | 2,091,075 | 211,973 | 7,935 | 134 | 3,271,162 |
| | 2 | 155,591 | 15,495 | 788 | 28 | 225,785 |
| | 3 | 202,143 | 16,208 | 678 | 12 | 286,595 |
| Coated | 1 | 5,224 | 524 | 28 | 31 | 7,411 |
| | 2 | 4,857 | 378 | 24 | 0 | 6,768 |
| | 3 | 1,733 | 170 | 12 | 0 | 2,439 |
| | | Percent Reduction (versus respective control) | | | | |
| | Extract | for Each Particle Bin | | | | |
| | # | 0.30-0.39 | 0.50-0.79 | 1.0-1.9 | >5 | >0.3 |
| Coated | 1 | 100% | 100% | 100% | 77% | 100% |
| | 2 | 97% | 98% | 97% | 100% | 97% |
| | 3 | 99% | 99% | 98% | 100% | 99% |

For example 2, all coupons were cleaned using Cleaning Method 2. Two copper coupons were coated and two copper coupons were left uncoated as controls. These coupons were tested by LPC extraction. The results are shown in Table 4. Each point is an average of the two coupons at each condition.

TABLE 4
LPC Extraction Results at 40 kHz for Example 2

| | Extract | | | | | |
|---|---|---|---|---|---|---|
| | # | 0.30-0.39μ | 0.50-0.79μ | 1.0-1.9μ | >5μ | >0.3μ |
| | | Particle Count per Surface Area for Each | | | | |
| | | Particle Bin (#/cm²) | | | | |
| Uncoated | 1 | 293,801 | 107,537 | 1,907 | 49 | 537,051 |
| Coated | 1 | 9,837 | 4,159 | 86 | 0 | 19,523 |
| | | Percent Reduction (versus respective control) | | | | |
| | | for Each Particle Bin | | | | |
| Coated | 1 | 97% | 96% | 95% | 100% | 96% |

### Examples 3, 4, and 5

| | Example Number | | |
|---|---|---|---|
| | 3 | 4 | 5 |
| Substrate Type | Stainless steel | FR4 plastic | Copper |
| Substrate Size | 50 mm × 25 | Irregular | 50 mm × 25 |
| | mm × 0.5 mm | 13.5 cm² | mm × 1.6 mm |
| Percent Solids | 10% | 10% | 10% |
| Pull Rate | 1.7 mm/sec | 3.5 mm/sec | 1.7 mm/sec |
| Cure Temperature | 150° C. | 150° C. | 150° C. |
| Cure Time | 30 minutes | 30 minutes | 30 minutes |

For Example 3, all the coupons were cleaned using Cleaning Method 1. Four coupons were coated and three coupons were left uncoated as controls. One coated coupon was tested for by the cross-cut tape test. No removal of the coating was observed. The remaining three coated and uncoated coupons were tested by LPC extraction. The results are shown in Table 6. Each data point in the table is the average of three coupons at each condition.

TABLE 6
LPC Extraction Results at 68 kHz for Example 3

| | Extract | | | | | |
|---|---|---|---|---|---|---|
| | # | 0.30-0.39μ | 0.50-0.79μ | 1.0-1.9μ | >5μ | >0.3μ |
| | | Particle Count per Surface Area for Each | | | | |
| | | Particle Bin (#/cm²) | | | | |
| Uncoated | 1 | 90,828 | 59,904 | 1,784 | 129 | 216,954 |
| | 2 | 156,342 | 163,231 | 4,654 | 197 | 489,132 |
| | 3 | 76,312 | 81,811 | 2,329 | 73 | 241,945 |
| Coated | 1 | 10,668 | 6,739 | 236 | 17 | 24,353 |
| | 2 | 4,165 | 1,471 | 26 | 0 | 8,206 |
| | 3 | 704 | 395 | 17 | 0 | 1,789 |
| | | Percent Reduction (versus respective control) | | | | |
| | | for Each Particle Bin | | | | |
| Coated | 1 | 88% | 89% | 87% | 87% | 89% |
| | 2 | 97% | 99% | 99% | 100% | 98% |
| | 3 | 99% | 100% | 99% | 100% | 99% |

For example 4, three coupons were coated and three coupons were left uncoated as controls. All coated and uncoated coupons were tested by LPC extraction. The results are shown in Table 7. Each data point in the table is the average of three coupons at each condition.

TABLE 7
LPC Extraction Results at 40 kHz for Example 4

| | Extract # | 0.30-0.39μ | 0.50-0.79μ | 1.0-1.9μ | >5μ | >0.3μ |
|---|---|---|---|---|---|---|
| | | Particle Count per Surface Area for | | | | |
| | | Each Particle Bin (#/cm²) | | | | |
| Uncoated | 1 | 792,653 | 2,169,800 | 203,314 | 10,822 | 4,236,593 |
| | 2 | 279,659 | 536,803 | 39,025 | 1,169 | 997,336 |
| | 3 | 88,346 | 135,550 | 8,378 | 280 | 246,548 |
| Coated | 1 | 29,594 | 181,155 | 11,094 | 716 | 329,425 |
| | 2 | 5,687 | 15,282 | 1,127 | 99 | 28,784 |
| | 3 | 10,229 | 25,224 | 1,638 | 82 | 47,183 |
| | | Percent Reduction (versus respective control) | | | | |
| | | for Each Particle Bin | | | | |
| Coated | 1 | 96% | 92% | 95% | 93% | 92% |
| | 2 | 98% | 97% | 97% | 92% | 97% |
| | 3 | 88% | 81% | 80% | 71% | 81% |

For example 5, all the coupons were cleaned using Cleaning Method 1. Four coupons were coated and three coupons were left uncoated as controls. One coated coupon was tested for by the cross-cut tape test. No removal of the coating was observed. The remaining three coated and uncoated coupons were tested by LPC extraction. The results are shown in Table 8. Each data point in the table is the average of three coupons at each condition.

TABLE 8
LPC Extraction Results at 40 kHz for Example 5

| | Extract # | 0.30-0.39μ | 0.50-0.79μ | 1.0-1.9μ | >5μ | >0.3μ |
|---|---|---|---|---|---|---|
| | | Particle Count per Surface Area for | | | | |
| | | Each Particle Bin (#/cm²) | | | | |
| Uncoated | 1 | 369,364 | 343,677 | 22,232 | 343 | 1,060,403 |
| | 2 | 271,159 | 307,735 | 16,969 | 433 | 879,594 |
| | 3 | 270,087 | 293,604 | 13,269 | 189 | 848,635 |
| Coated | 1 | 68,989 | 48,632 | 2,210 | 0 | 171,248 |
| | 2 | 58,536 | 46,749 | 1,596 | 43 | 156,443 |
| | 3 | 53,025 | 50,030 | 1,702 | 492 | 157,112 |
| | | Percent Reduction (versus respective control) | | | | |
| | | for Each Particle Bin | | | | |
| Coated | 1 | 81% | 86% | 90% | 100% | 84% |
| | 2 | 78% | 85% | 91% | 90% | 82% |
| | 3 | 80% | 83% | 87% | −160% | 81% |

### Example 7

TABLE 9
Example 7 Parameters for Coating

| | |
|---|---|
| Substrate Type | Aluminum 6061 |
| Substrate Size | 50 mm × 25 mm × 1.6 mm |
| Percent Solids | 10% |
| Pull Rate | 1.7 mm/sec |
| Cure Temperature | 150° C. |
| Cure Time | 30 minutes |

For example 7, all the coupons were cleaned using Cleaning Method 1. Four coupons were coated and three coupons were left uncoated as controls. One coated coupon was tested for by the cross-cut tape test. No removal of the coating was observed. The remaining three coated and uncoated coupons were tested by LPC extraction. The results are shown in Table 10. Each data point in the table is the average of three coupons at each condition.

TABLE 10
LPC Extraction Results at 40 kHz for Example 7

| | Extract # | 0.30-0.39μ | 0.50-0.79μ | 1.0-1.9μ | >5μ | >0.3μ |
|---|---|---|---|---|---|---|
| | | Particle Count per Surface Area for | | | | |
| | | Each Particle Bin (#/cm²) | | | | |
| Uncoated | 1 | 2,056,071 | 691,424 | 10,594 | 51 | 3,603,423 |
| | 2 | 772,275 | 201,804 | 2,841 | 4 | 1,330,830 |
| | 3 | 323,195 | 141,062 | 2,226 | 28 | 642,540 |
| | 4 | 290,401 | 173,202 | 2,833 | 87 | 689,191 |
| Coated | 1 | 40,879 | 21,491 | 1,079 | 83 | 91,232 |
| | 2 | 27,113 | 10,283 | 209 | 16 | 52,154 |
| | 3 | 20,392 | 10,941 | 181 | 8 | 46,059 |
| | | 19,033 | 8,793 | 185 | 0 | 39,469 |
| | | Percent Reduction (versus respective control) | | | | |
| | | for Each Particle Bin | | | | |
| Coated | 1 | 98% | 97% | 90% | −61% | 97% |
| | 2 | 96% | 95% | 93% | −306% | 96% |
| | 3 | 94% | 92% | 92% | 72% | 93% |
| | | 93% | 95% | 93% | 100% | 94% |

### Example 8

TABLE 11
Example 8 Parameters for Coating

| | |
|---|---|
| Substrate Type | Aluminum 6061 |
| Substrate Size | 50 mm × 25 mm × 1.6 mm |
| Percent Solids | 10% |
| Pull Rate | 1.7 mm/sec |
| Cure Temperature | 150° C. |
| Cure Time | 30 minutes |

For example 8, all the coupons were cleaned using Cleaning Method 1. Four coupons were coated and three coupons were left uncoated as controls. One coated coupon was tested for by the cross-cut tape test. No removal of the coating was observed. The remaining three coated and uncoated coupons were tested by LPC extraction. The results are shown in Table 12. Each data point in the table is the average of three coupons at each condition.

TABLE 12
LPC Extraction Results at 40 kHz for Example 8

| | Extract # | 0.30-0.39μ | 0.50-0.79μ | 1.0-1.9μ | >5μ | >0.3μ |
|---|---|---|---|---|---|---|
| | | Particle Count per Surface Area for | | | | |
| | | Each Particle Bin (#/cm²) | | | | |
| Uncoated | 1 | 1,332,983 | 426,076 | 12,213 | 950 | 2,298,313 |
| | 2 | 349,796 | 124,188 | 3,093 | 63 | 632,763 |
| | 3 | 68,063 | 49,353 | 1,796 | 55 | 173,329 |
| Coated | 1 | 22,669 | 43,684 | 2,368 | 103 | 99,975 |
| | 2 | 17,989 | 38,972 | 1,934 | 79 | 87,245 |
| | 3 | 19,482 | 33,381 | 1,351 | 20 | 81,410 |
| | | Percent Reduction (versus respective control) | | | | |
| | | for Each Particle Bin | | | | |
| Coated | 1 | 98% | 90% | 81% | 89% | 96% |
| | 2 | 95% | 69% | 37% | −25% | 86% |
| | 3 | 71% | 32% | 25% | 64% | 53% |

### Example 9

TABLE 13
Example 9 Coating Parameters

| | |
|---|---|
| Substrate Type | Aluminum 5052 H32 |
| Substrate Size | 50 mm × 25 mm × 1.6 mm |
| Percent Solids | 6.7% |
| Pull Rate | 2.54 mm/sec |
| Cure Temperature | 120° C. |
| Cure Time | 1 hour |

For example 9, all coupons were cleaned using Cleaning Method 3. Four coupons were coated and three coupons were left uncoated as controls. One coated coupon was tested by the cross-cut adhesion test. No removal of coating was observed. The remaining coated and uncoated coupons were tested by LPC extraction. The results are shown in Table 14. Each data point is an average of three coupons at each condition.

TABLE 14
LPC Extraction Results at 68 kHz for Example 9

| | Extract | | | | |
|---|---|---|---|---|---|
| Sample | # | 0.30-0.39μ | 0.50-0.79μ | 1.0-1.9μ | >0.3μ |
| | | Particle Count per Surface Area for Each Particle | | | |
| | | Bin (#/cm²) | | | |
| Uncoated | 1 | 61,569 | 14,196 | 1,186 | 114,331 |
| | 2 | 38,905 | 6,977 | 474 | 66,709 |
| | 3 | 36,450 | 6,031 | 461 | 61,976 |
| Coated | 1 | 2,926 | 893 | 222 | 6,298 |
| | 2 | 3,587 | 534 | 45 | 5,996 |
| | 3 | 3,193 | 559 | 69 | 5,535 |
| | | Percent Reduction (versus respective control) | | | |
| | | for Each Particle Bin | | | |
| Coated | | 95% | 94% | 81% | 94% |
| | | 91% | 92% | 90% | 91% |
| | | 91% | 91% | 85% | 91% |

### Example 10

TABLE 14
Example 10 Coating Parameters

| | |
|---|---|
| Substrate Type | Aluminum 5052 H32 |
| Substrate Size | 50 mm × 25 mm × 1.6 mm |
| Percent Solids | 10.3% |
| Pull Rate | 2.54 mm/sec |
| Cure Temperature | 120° C. |
| Cure Time | 1 hour |

For example 10, all coupons were cleaned using Cleaning Method 3. Four coupons were coated and three coupons were left uncoated as controls. One coated coupon was tested by the cross-cut adhesion test. No removal of coating was observed. The remaining coated and uncoated coupons were tested by LPC extraction. The results are shown in Table 16. Each data point is an average of three coupons at each condition.

TABLE 16
LPC Extraction Results at 68 kHz for Example 10

| | Extract | | | | |
|---|---|---|---|---|---|
| Sample | # | 0.30-0.39μ | 0.50-0.79μ | 1.0-1.9μ | >0.3μ |
| | | Particle Count per Surface Area for Each Particle | | | |
| | | Bin (#/cm²) | | | |
| Uncoated | 1 | 61,569 | 14,196 | 1,186 | 114,331 |
| | 2 | 38,905 | 6,977 | 474 | 66,709 |
| | 3 | 36,450 | 6,031 | 461 | 61,976 |
| Coated | 1 | 2,349 | 363 | 96 | 4,027 |
| | 2 | 3,976 | 532 | 62 | 6,316 |
| | 3 | 2,269 | 367 | 40 | 3,881 |
| | | Percent Reduction (versus respective control) | | | |
| | | for Each Particle Bin | | | |
| Coated | 1 | 96% | 97% | 92% | 96% |
| | 2 | 90% | 92% | 87% | 91% |
| | 3 | 94% | 94% | 91% | 94% |

1. A substrate comprising a coating on at least a portion of said substrate wherein said coating comprises the reaction product of a material comprising a fluorochemical moiety and reactive pendant groups, and said substrate is a hard disk drive assembly comprising at least one head associated with a disk surface for storing computer data magnetically on the disk.

2. The substrate of claim 1 wherein said coating comprises the reaction product of a material having the general structure:
(RO)₃Si—(CH₂)_{b}—NHC(O)CX¹F—(O(CFR¹)ₐ)ₚ(O(CFR²CF₂)ₐ)_{q}—OCFX²C(O)NH—(CH₂)_{b}—Si(OR)₃
wherein R is a methyl or an ethyl group, R¹ and R², which may be the same or different, are F or CF₃, X¹ and X² which may be the same or different, are F or CF₃, a is an integer from 1 to 4 thereof, b is an integer from 1 to 10, p is an integer from 1 to 145, q is an integer from 0 to 145, and a number average molecular weight from about 500 to about 10,000.

3. The substrate of claim 1 wherein said coating comprises the reaction product of a material having the general structure: 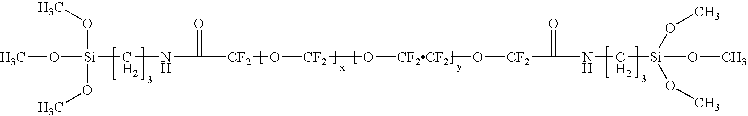
wherein x is an integer from 0 to 150 and y is an integer from 0 to 85 with the proviso that x and y are not both 0.

4. The substrate of claim 1 wherein said coating comprises the reaction product of a material having the general structure:
(RO)₃Si—(CH₂)_{b}—NHC(O)CXF(OC₃F₆)_{y}O(CF₂)_{z}O(C₃F₆O)ₓCFXC(O)NH—(CH₂)_{b}—Si(OR)₃
wherein R may be a methyl or ethyl group, X is F or CF₃, x and y may be the same or different and are each an integer from 0 to 10, with the proviso that at least one is not 0, and z is an integer from 2 to 10.

5. The substrate of claim 1 wherein said coating comprises the reaction product of a material selected from the group consisting of materials having the general structure:

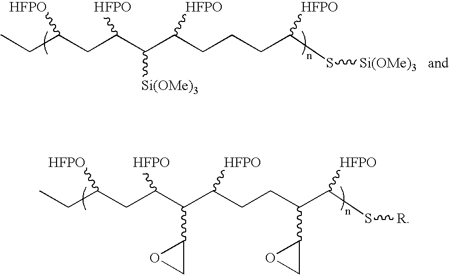

6. The substrate of claim 1 wherein said reactive pendant groups are selected from the group consisting of reactive silanes reactive epoxies, reactive carboxylic acids, and reactive hydroxyls.

7. (canceled)
